(19) United States
(12) Patent Application Publication
(10) Pub. No.: US 2015/0353299 A1
(43) Pub. Date: Dec. 10, 2015

(54) ORDER PICKING STATION AND METHOD OF ORDER PICKING

(71) Applicant: Sergey N. RAZUMOV, Moscow (RU)

(72) Inventor: Sergey N. RAZUMOV, Moscow (RU)

(21) Appl. No.: 14/299,527

(22) Filed: Jun. 9, 2014

(51) Int. Cl. B65G 63/00; B65G 63/02; B65G 65/08; B65G 65/00

(52) U.S. Cl. CPC B65G 63/004; B65G 65/005; B65G 63/025; B65G 65/08; B65G 2201/025; B65G 2203/0283; B65G 2207/14; B65G 2209/02; B65G 2209/04

(57) ABSTRACT

An order picking system enables a picker at a picking position to collect orders from multiple containers. A container feeding mechanism moves containers along a feeding line to and from the picking position in multiple container holders positioned in first and second rows at different horizontal levels with respect to ground. The container feeding mechanism is configured for simultaneously moving the container holders in the first row to the picking position and the container holders in the second row from the picking position. Multiple container carriages are moved along multiple parallel tracks in a direction substantially perpendicular to the feeding line so as to carry containers to and from the container feeding mechanism.

### TECHNICAL FIELD

This disclosure relates to retail logistics, and more particularly, to an order picking station that enables a picker to collect orders from multiple containers provided to the picker in a predefined sequence.

### BACKGROUND ART

Order picking operations involve extracting specified goods from a storage area in a retail facility, and collecting them to prepare a customer's order. Order picking processes have become the most labor-intensive and costly part of the supply chain for any retail environment.

A conventional order picking process involves a storage area that contains goods, and a picking area in which a human picking operator or a picking device extracts the goods from different containers delivered from the storage area and places them into a container prepared for delivery to a customer. In traditional storage systems, an order picking process employs a combination of lift trucks, conveyors, and manual operations. However, complex logistics and substantial labor cost are involved when a large number of orders must be processed.

Therefore, it would be desirable to develop an order picking system capable of performing order picking operations in a quick and efficient manner.

Also, during an order picking process, there is a need for providing containers to a human picking operator or a picking device in a predetermined sequence so as to enable the operator or picking device to pick products required to fulfill orders sequentially. For instance, to fulfill the first order, products stored in a first group of containers may be required, to fulfill the second order, products from a second group of containers may be needed, and to fulfill the third order, products from a third group of containers should be delivered. In this case, it would be desirable to provide a picker with a sequence of containers in which the second group of containers follows the first group containers, and the third group follows the second group.

Also, an order may include multiple products that should be packed in a specific sequence. For example, heavy products need to be placed at the bottom of the container, while lightweight products may be placed after the heavy products. In this case, to efficiently fulfill the order, it would be desirable for each order to provide a picker with containers with the heavy products before containers with the lightweight products.

Further, it would be convenient to provide a picker with containers in a predefined sequence to enable the picker to place some items of an order separately from other items. For example, frozen products have to be placed separately from fresh products, food items need to be placed separately from chemical items, etc.

### SUMMARY OF THE DISCLOSURE

In accordance with one aspect, the present disclosure offers an order picking system for enabling a picker at a picking position to collect orders from multiple containers. The system includes a container feeding mechanism configured for moving containers to and from the picking position along a feeding line in multiple container holders positioned in first and second rows at different horizontal levels with respect to ground. The container feeding mechanism is configured for simultaneously moving the container holders in the first row to the picking position in a first direction and the container holders in the second row from the picking position in a second direction opposite to the first direction.

Multiple container carriages are moved along multiple parallel tracks in a direction substantially perpendicular to the feeding line so as to carry containers to and from the container feeding mechanism. Each container carriage has a board for carrying one or more containers. The container carriage is configured for placing the board into first and second horizontal positions respectively corresponding to the first and second rows of the container feeding mechanism.

The container carriage places one or more containers into a container holder in the first row when the board is in the first horizontal position, and takes one or more containers removed from a container holder in the second row when the board is in the second horizontal position. For example, the container holders in the second row may be positioned at a higher horizontal level than the container holders in the first row.

A storage rack having multiple storage cells may store containers in at least one row arranged at a horizontal level corresponding to the second row of the container holders. The container feeding mechanism may move containers from the container holders in the second row to the storage cells of the storage rack. The container carriages may remove containers from the storage cells of the storage rack when the board is in the second position.

In accordance with another aspect of the disclosure, multiple container carriages may deliver a sequence of containers in a predefined order to the container feeding mechanism. In particular, a first container carriage may deliver one or more first containers of the sequence and a second container carriage may deliver one or more second containers following the one or more first containers in the sequence. A buffer area may be provided for holding the second container carriage with the one or more second containers until the first container carriage with the one or more first containers arrives.

The container feeding mechanism may simultaneously receive the one or more first containers in a first container holder and the one or more second containers in a second container holder, where the first container holder is arranged closer to the picker than the second container holder.

In accordance with a further aspect of the present disclosure, an order picking method is carried out for enabling a picker to collect an order from multiple containers provided to the picker in a predefined sequence including one or more first containers and one or more second containers following the one or more first containers in the sequence. The method uses a container feeding mechanism configured for moving containers to and from the picker along a feeding line in multiple container holders. The method comprises the steps of:
delivering containers to a buffer area using multiple container carriages movable along multiple parallel tracks substantially perpendicular to the feeding line, the multiple container carriages including a first container carriage for carrying the one or more first containers and a second container carriage for carrying the one or more second containers,
holding the second container carriage in the buffer area until the first container carriage arrives,
controlling the first container carriage for placing the one or more first containers into a first container holder of the multiple container holders,
controlling the second container carriage for placing the one or more second containers into a second container holder of the multiple container holders substantially simultaneously with placing the one or more first containers into the first container holder, and
moving the multiple container holders using the container feeding mechanism so as to place the first container holder into a picking position accessible by the picker before the second container holder is placed into the picking position.

The predefined sequence of containers may further include one or more third containers following the first and second containers. The third containers may be delivered to the buffer area using a third container carriage, and may be held in the buffer area until the first and second container carriages arrive.

Thereafter, the third container carriage may be controlled to place the third containers into a third container holder of the multiple container holders substantially simultaneously with placing the first and second containers into the first and second container holders. The container holders may be moved using the container feeding mechanism so as to place the third container holder into the picking position after the first and second container holders are placed into the picking position.

Additional advantages and aspects of the disclosure will become readily apparent to those skilled in the art from the following detailed description, wherein embodiments of the present disclosure are shown and described, simply by way of illustration of the best mode contemplated for practicing the present disclosure. As will be described, the disclosure is capable of other and different embodiments, and its several details are susceptible of modification in various obvious respects, all without departing from the spirit of the disclosure. Accordingly, the drawings and description are to be regarded as illustrative in nature, and not as limitative.

### BRIEF DESCRIPTION OF THE DRAWINGS

The following detailed description of the embodiments of the present disclosure can best be understood when read in conjunction with the following drawings, in which the features are not necessarily drawn to scale but rather are drawn as to best illustrate the pertinent features, wherein:

FIG. 1 shows an exemplary embodiment of an order picking system in accordance with the present disclosure.

FIGS. 2 and 3 illustrate elements of an exemplary order picking station.

FIGS. 4-6 illustrate placing a set of containers into a container holder of a container feeding mechanism.

FIGS. 7-15 illustrate exemplary operations of the order picking system carried out to enable a picker to collect an order from multiple containers provided in a predefined sequence.

### DETAILED DESCRIPTION OF THE EMBODIMENTS

The present disclosure will be made using exemplary storage environment discussed below. It will become apparent, however, that the concept of the disclosure is applicable to any order picking system in a retail or warehouse environment.

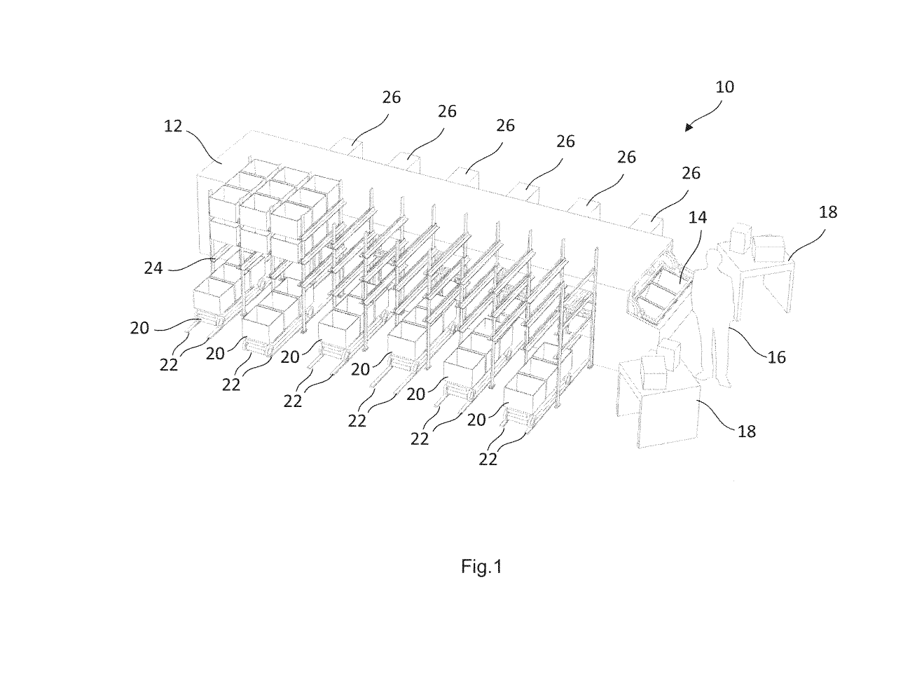

FIG. 1 illustrates an exemplary embodiment of an order picking station 10 in accordance with the present disclosure. The order picking station 10 may be arranged in a warehouse, fulfillment center or retail facility. The order picking station 10 includes a container feeding mechanism 12 configured for supplying containers with products along a feeding line to a picking position 14 where a picker 16 collects products from the supplied containers to prepare orders.

Although FIG. 1 shows the picker 16 as a human operator, the picker 16 may be any picking device configured to prepare orders by collecting products from different containers. The containers may be any objects capable of holding goods stored in a storage area, such as cartons, boxes, crates, or pallets. The order picking station 10 may include order preparing tables 18 used by the picker 16 to fill empty containers with products collected from the containers supplied by the container feeding mechanism 12.

As discussed in more detail later, multiple container carriages 20 are used to deliver containers from a storage area to the order picking station 10, and to place the containers into the container feeding mechanism 12. For example, the container carriages 20 may be configured for moving along corresponding pairs of rails 22 that may be arranged in parallel in a direction substantially perpendicular to the feeding line of the container feeding mechanism 12. The container carriages 20 may be controlled to deliver containers from the storage area in a predefined sequence. For example, a system for transferring containers in a desired sequence using the container carriages 20 is described in my copending U.S. patent application Ser. No.14/178,024, filed on Feb. 11, 2014, entitled “MULTI-LEVEL STORAGE SYSTEM WITH TRANSPORTATION DEVICES MOVABLE IN SUBSTANTIALLY PERPENDICULAR DIRECTIONS AND METHOD OF TRANSFERRING CONTAINERS IN DESIRED SEQUENCE,” and incorporated herewith by reference.

A storage rack 24 is arranged adjacent to the container feeding mechanism 12 for storing containers in multiple storage cells arranged in multiple rows. The storage rack 24 includes a buffer row having multiple buffer storage cells aligned with respect to the rails 22 so as to enable the container carriages 20 to take the containers held in the buffer storage cells provided above the corresponding rails 22. A moving mechanism 26 is provided for moving containers from the container feeding mechanism 12 to the buffer storage cells.

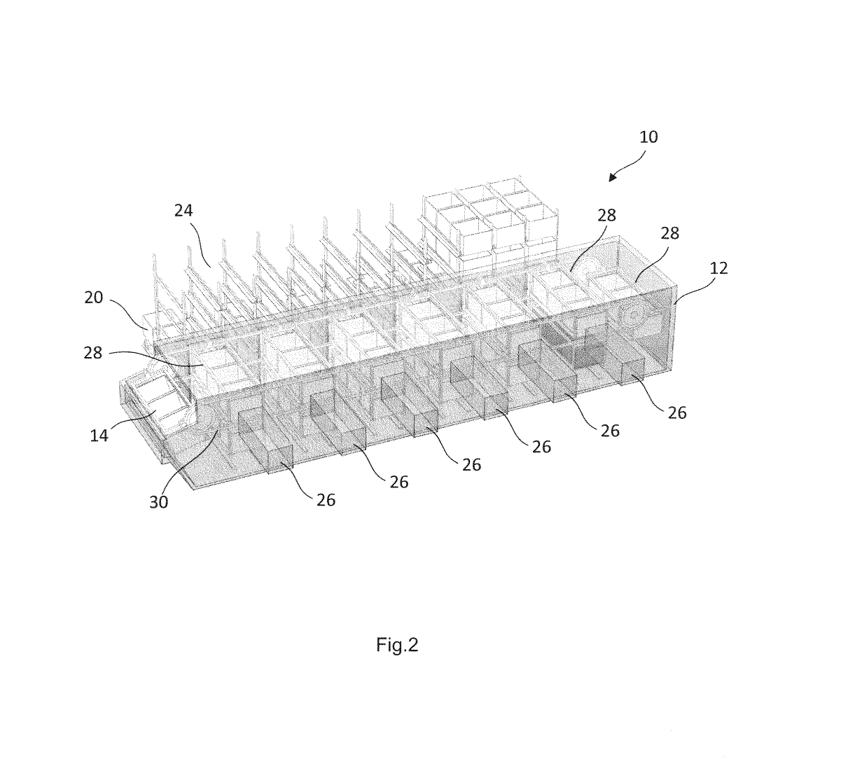

As illustrated in FIG. 2, the container feeding mechanism 12 includes multiple container holders 28 configured for moving containers along a feeding line to and from the picking position 14. Each container holder 28 is configured for holding a set of containers delivered by a single container carriage 20. For example, FIG. 2 shows that a set of three containers may be held in each container holder 28.

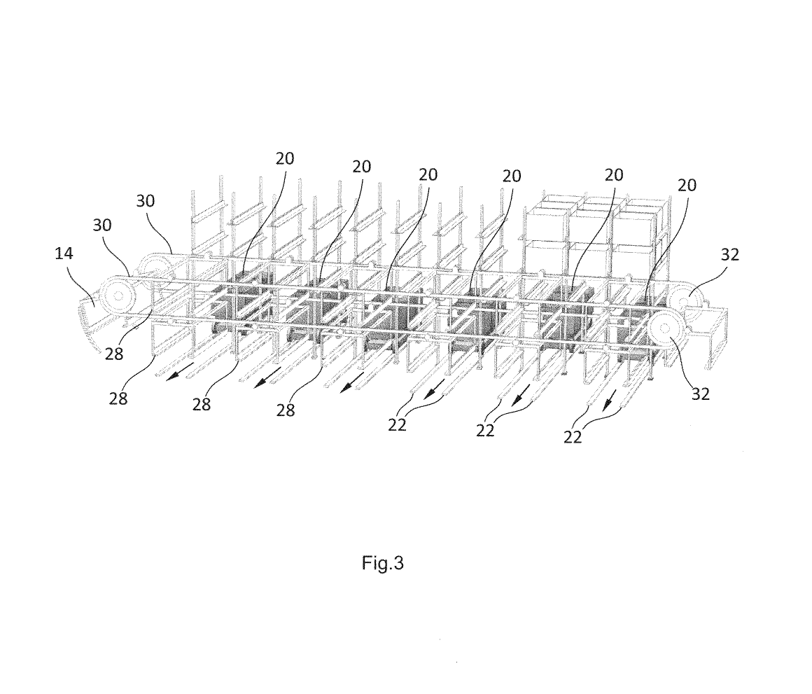

The container holders 28 may be positioned in two rows at different horizontal levels with respect to ground. A drive mechanism with a flexible drive member such as a chain drive or a belt drive mechanism may be used for moving the container holders 28 positioned in a lower row to the picking position 14. Simultaneously, the container holders 28 positioned in an upper row are moved from the picking position 14. For example, as illustrated in FIGS. 2 and 3, the container holders 28 may be pivotally attached to a roller chain 30 driven by a pair of sprockets 32 so as to transfer the container holders 28 in opposite directions to and from the picking position 14.

FIG. 3 shows that multiple container carriages 20 deliver containers to the container feeding mechanism 12 along multiple pairs of rails 22 arranged in parallel in a direction substantially perpendicular to a container feeding line along which the container holders 28 are transferred to and from the picking position 14. The container feeding mechanism 12 is controlled to align the container holders 28 positioned in a lower row with respect to the rails 22 so as to enable the container carriages 20 to place the container sets into the respective container holders 28.

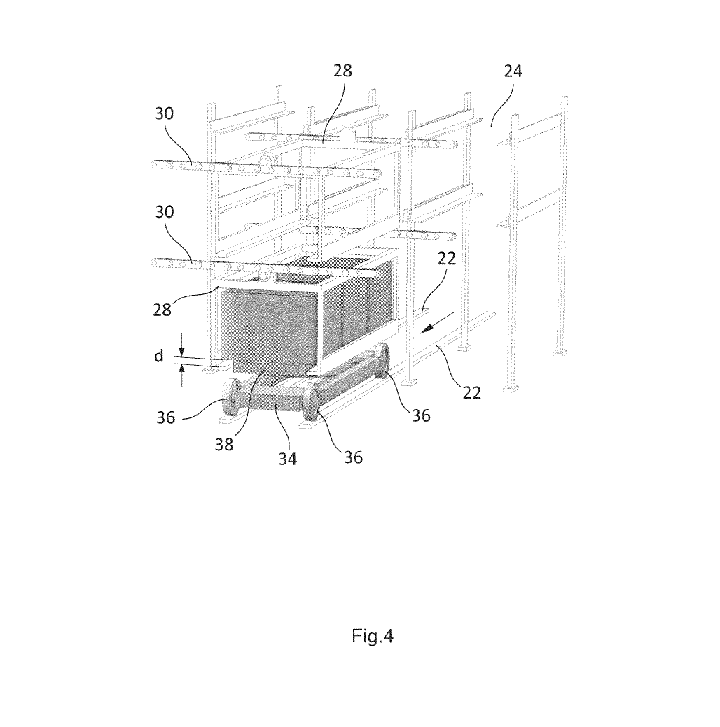

FIGS. 4-6 illustrate placing a set of containers carried by a container carriage 20 into a container holder 28. The container carriage 20 may include a frame 34 with four wheels 36 fixed to the frame 34 which may be formed as a braced structure for supporting elements required to operate the container carriage 20. Each wheel 36 may be attached to the frame 34 so as to rotate in a vertical plane about an axis extending from the center of the wheel 36 in order to move the container carriage 20 along the rails 22.

The frame 34 may hold a board 38 that can be used for carrying a set of containers. For example, the board 38 may be a rectangular metal plate configured to accommodate containers. A pantographic mechanism may be provided on the frame 34 to raise the board 38 with respect to the frame 34. In particular, as shown in FIG. 4, the container carriage 20 may be moved along the rails 22 with the board 38 raised at a level d with respect to the frame 34. This level is selected to raise the board 38 slightly above lower holding elements of the container holder 28 so as place the container set carried by the board 38 into the container holder 28.

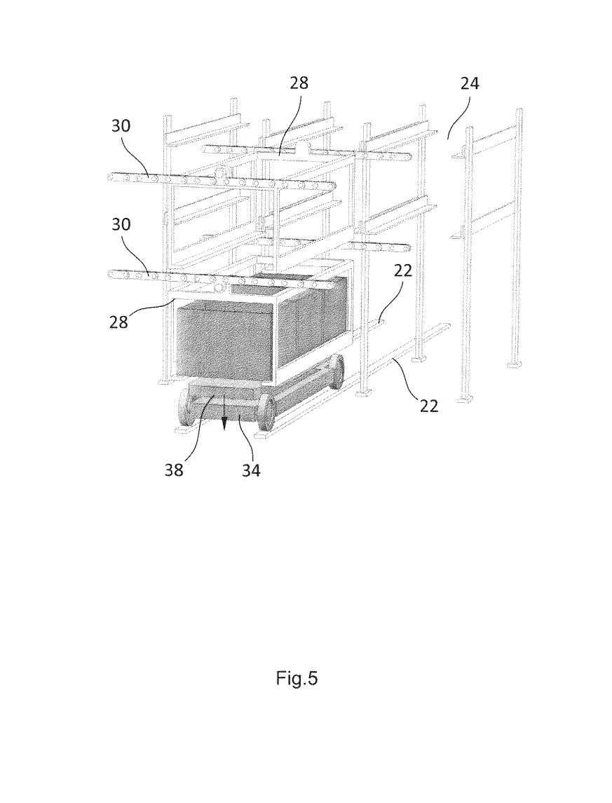

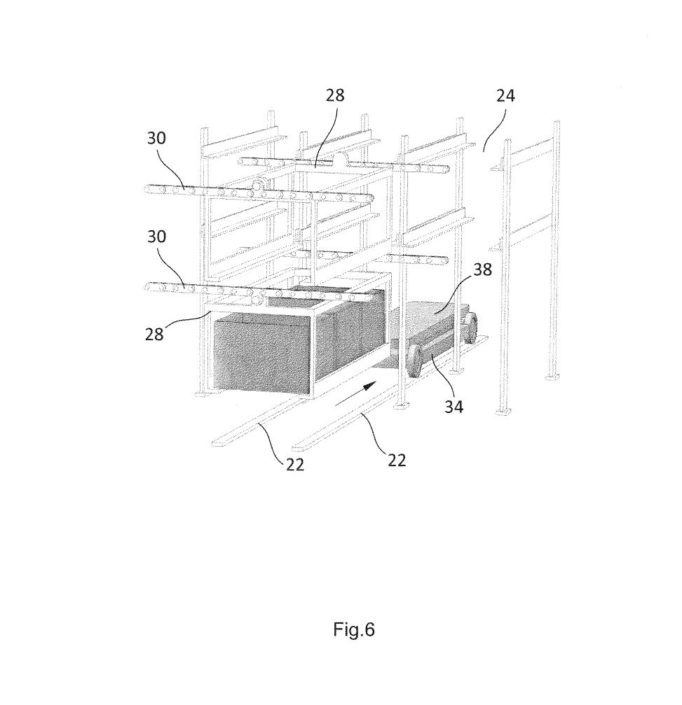

The width of the board 38 is made less than the horizontal distance between the holding elements of the container holder 28 so as to allow the container carriage 20 to move the board 38 down while leaving the set of containers held by the holding elements of the container holder 28 (FIG. 5). Thereafter, as shown in FIG. 6, the container carriage 20 with the board 38 lying down on the frame 34 is moved along the rails 22 from the container feeding mechanism 12.

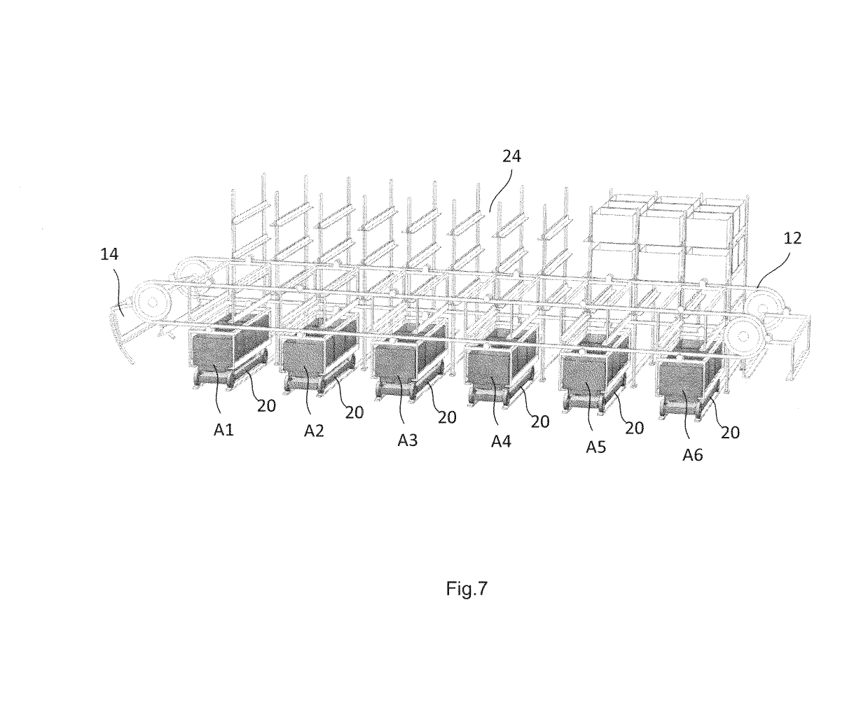

FIG. 7 illustrates multiple container carriages 20 that place container sets A1 to A6 into respective container holders 28 positioned in the lower row of the container feeding mechanism 12. As discussed above, the container carriages 20 may be controlled to deliver containers in a predefined sequence required to enable a picker 16 to prepare orders in an efficient manner.

For example, the predefined sequence of containers may include the container set A1 followed by the container set A2, which followed by the container set A3 followed by the container sets A4, A5 and A6. In this case, the container carriage 20 carrying the container set A1 is controlled to place the container set A1 into the container holder 28 closest to the picking position 14. The next container set A2 is placed into the next container holder 28, etc. The last container set A6 in the sequence is placed into the container holder 28 positioned at a greater distance from the picking position 14 than the container holders 28 holding the preceding container sets in the sequence.

The container carriages 20 may be controlled to place the container sets A1 to A6 into the respective container holders 28 at the same time. The number of container sets placed into the container feeding mechanism 12 at the same time may correspond to the number of the container holders 28 in the lower row of the container feeding mechanism 12.

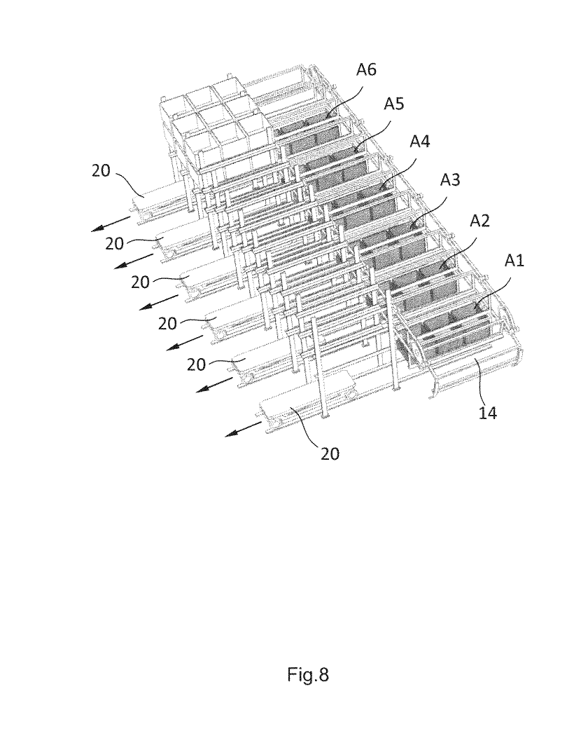

As shown in FIG. 8, after the container sets A1 to A6 are placed into the respective container holders 28, the container carriages 20 are moved along the respective rails back to the storage area to collect the next container sets to be delivered to the order picking station 10.

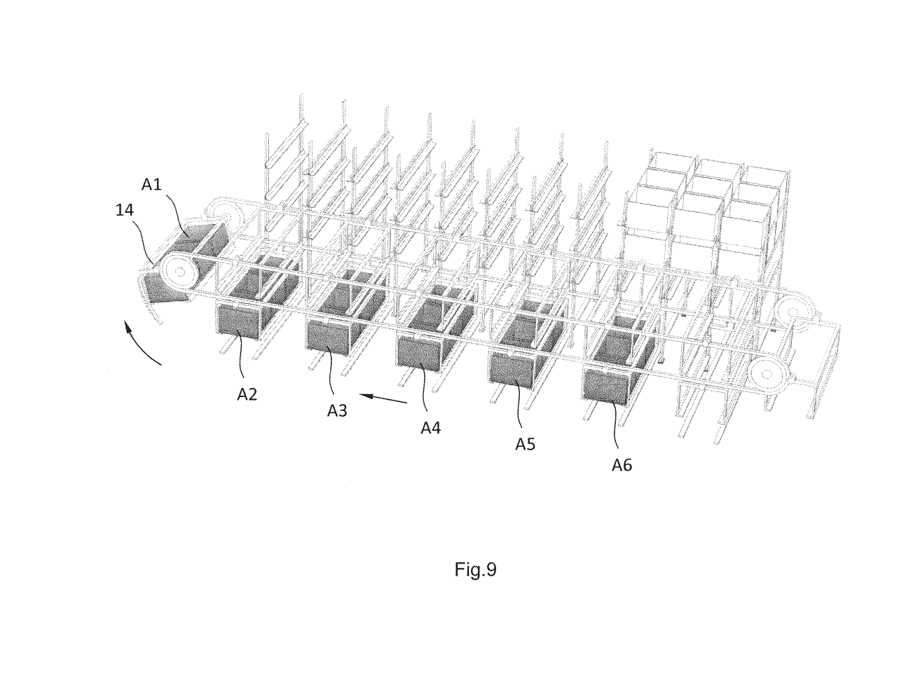

As illustrated in FIG. 9, when the container sets A1 to A6 are in the container holders 28 positioned in the lower row, the container feeding mechanism 12 is controlled to move the container holders 28 with the container sets A1 to A6 in a direction of the picking position 14 so as to place the container holder 28 with the container set A1 into the picking position 14. Simultaneously, each of the container holders 28 with the container sets A2 to A6 are also moved to a position previously occupied by the container holder 28 with the preceding container set. When the container set A1 is in the picking position 14, the picker 16 is enabled to collect products from the containers of the set A1.

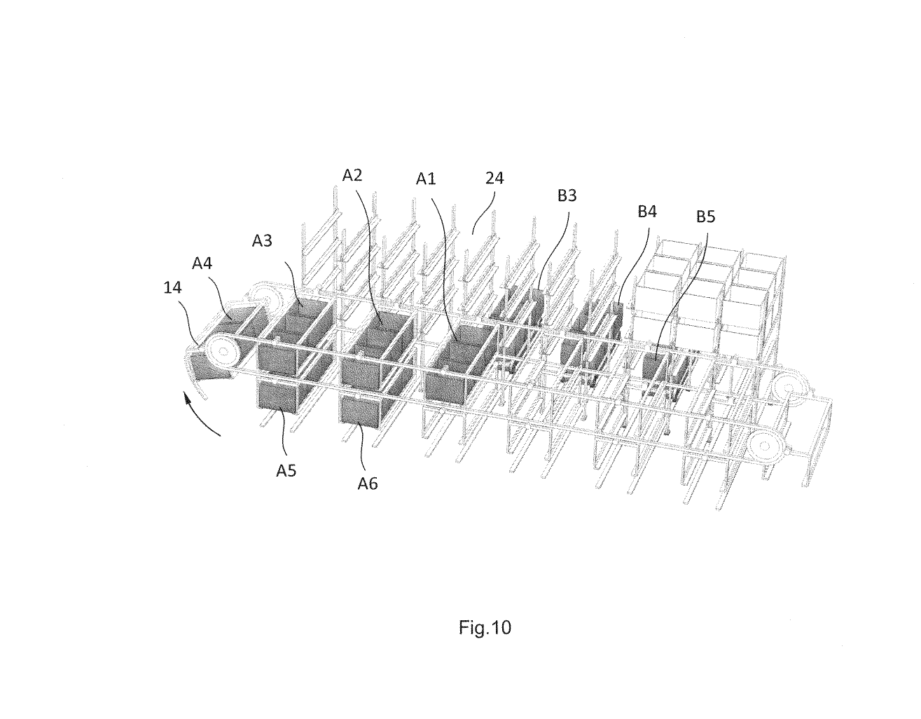

Thereafter, the container feeding mechanism 12 is controlled to move the container holder 28 with the next container set A2 into the picking position 14. At the same time, the container holder 28 with the previously processed container set A1 is moved from the picking position 14 and is positioned in the upper row of the container feeding mechanism 12. Hence, the container sets A1 to A6 are sequentially moved in a direction of the picking position 14 to enable their processing. At the same time, previously processed container sets are moved in the upper row in the opposite direction. For example, FIG. 10 illustrates a position of the container feeding mechanism 12, in which the container holder 28 with the container set A4 is placed into the picking position 14. As shown in this drawing, the container holders 28 with previously processed container sets A1 to A3 are positioned in the upper row for moving from the picking position 14.

While the picker 16 processes a first group of containers composed of the container sets A1 to A6, the container carriages 20 collect in the storage area the next group of containers in a predefined sequence of containers. For example, the next group of containers is composed of container sets B1 to B6. To ensure that the picker 16 is supplied with containers in the predefined sequence, the order picking station 10 includes a buffer area provided adjacent to the container feeding mechanism 12 below the storage rack 24. The buffer area serves to accumulate container carriages 20 until all container carriages 20 carrying container sets B1 to B6 of the second group arrive.

For example, as illustrated in FIG. 10, the container carriages 20 with container sets B3, B4 and B5 arrive before the container carriages 20 with preceding container sets B1, B2, and before the container carriage 20 with the container set B6. The order picking station 10 is controlled to hold the container carriages 20 with container sets B3, B4 and B5 in the buffer area until all of the container carriages 20 with the other container sets in the second group arrive.

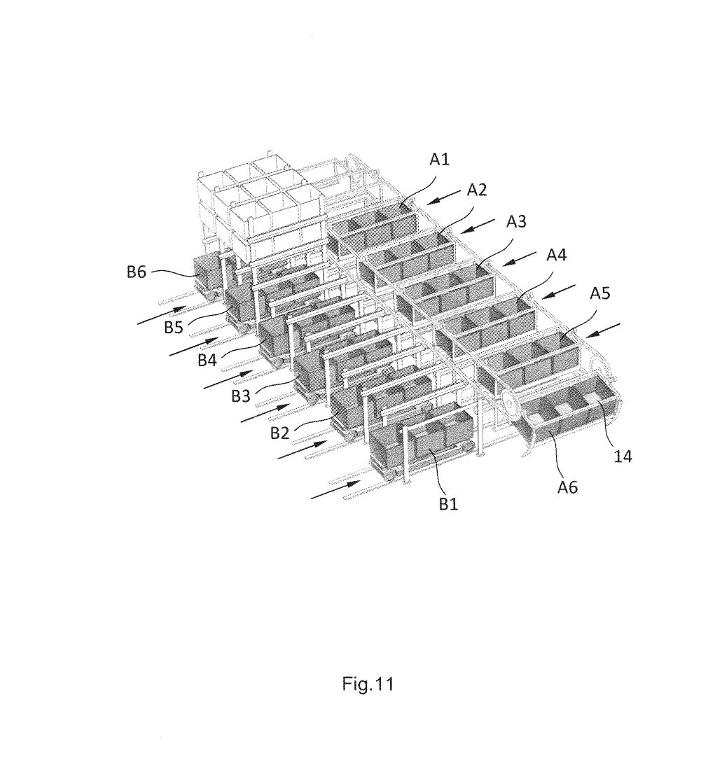

As shown in FIG. 11, when all of the container carriages 20 carrying container sets B1 to B6 of the second group of containers are positioned in the buffer area, and the last container set A6 in the first group of containers is placed into the picking position 14, the container carriages 20 with container sets B1 to B6 are moved from the buffer area to empty container holders 28 in the lower row of the container feeding mechanism 12 so as to place the container sets B1 to B6 into the respective container holders 28.

At the same time, the moving mechanism 26 moves containers of the container sets A1-A5 from the container holders 28 in the upper row of the container feeding mechanism 14 to the buffer storage cells in the buffer row of the storage rack 24. For example, the moving mechanism 26 may be implemented using a push mechanism configured for pushing containers from the container holders 28 in the upper row to respective buffer storage cells of the buffer row arranged at a vertical level corresponding to the vertical level of the upper row of the container feeding mechanism 12.

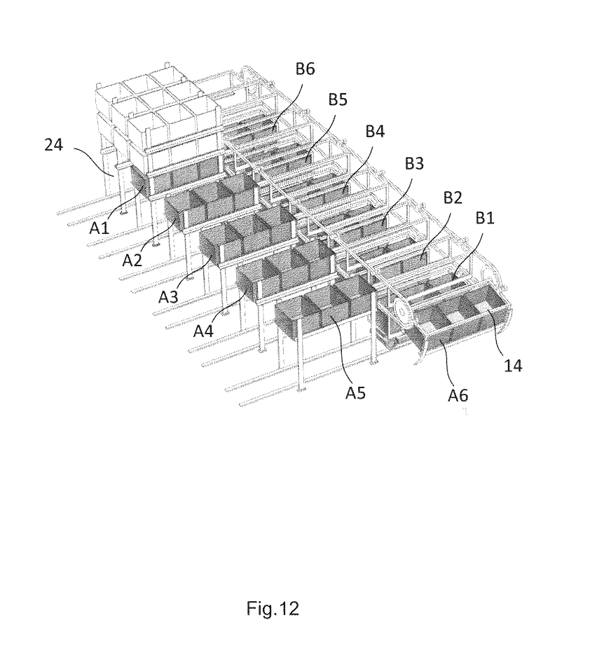

FIG. 12 illustrates that while the container carriages 20 with container sets B1-B6 take positions to place the container sets B1-B6 in the container holders 28 in the lower row, container sets A1-A5 are moved to the respective buffer storage cells of the storage rack 24. At that time, the picker 16 collects products from containers of the container set A6 placed into the picking position 14.

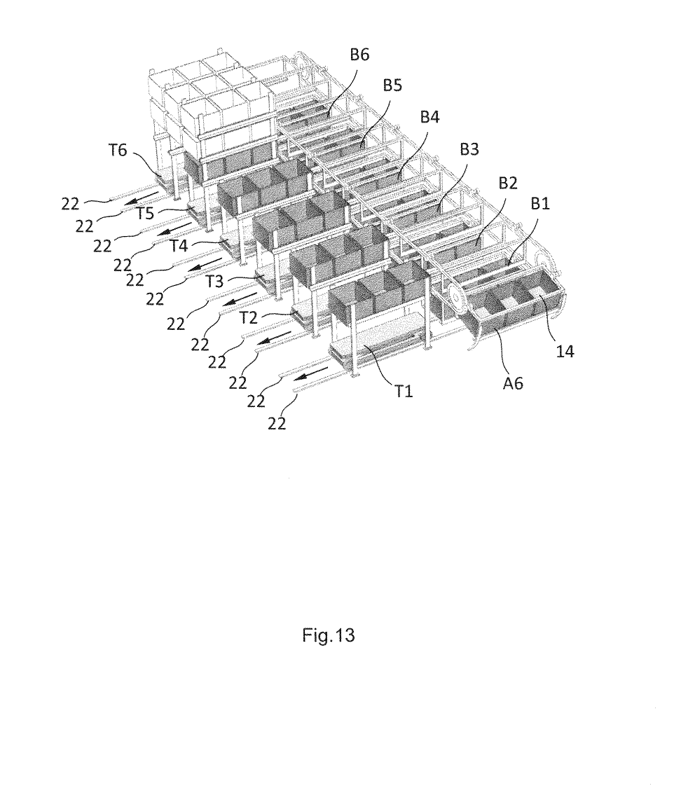

In FIG. 13, the container carriages 20 used for delivery of container sets B1 to B6 are designated by reference numbers T1 to T6, respectively. As illustrated in this drawing, after the container carriages T1 to T6 place container sets B1 to B6 into the container holders 28 in a manner discussed before, the container carriages T1 to T6 are moved along the rails 22 back to the buffer area. The container carriages T1 to T5 used for delivery of container sets B1 to B5 are positioned below the buffer storage cells holding container sets A5 to A1, respectively.

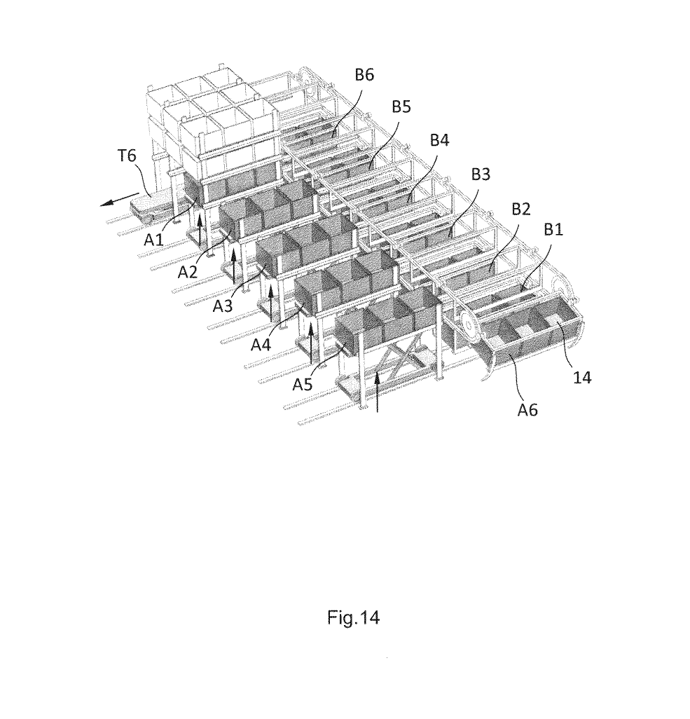

Thereafter, as shown in FIG. 14, the boards 38 of the carriages T1 to T5 are raised to a position slightly above lower holding elements of the buffer storage cells so as to place the container sets A5 to A1 at the boards 38. The width of the carriage's board 38 is made less than the horizontal distance between the holding elements of the buffer storage cell so as to allow the container carriage to raise the board 38 above the lower holding elements in order to place the respective container on the board 38.

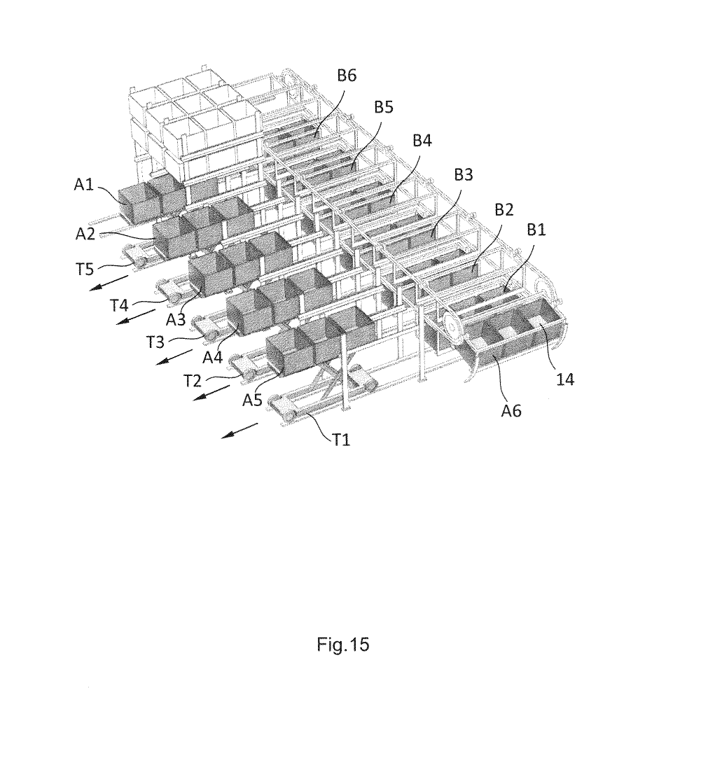

Then, as illustrated in FIG. 15, the container carriages T1 to T5 with the container sets A5 to A1, respectively, are moved from the container feeding mechanism 12 to deliver the container sets A5 to A1 back to the storage area, and to collect container sets of the next group in the storage area. The container carriage T6 is also moved to the storage area to collect containers of the next group.

The foregoing description illustrates and describes aspects of the present invention. Additionally, the disclosure shows and describes only preferred embodiments, but as aforementioned, it is to be understood that the invention is capable of use in various other combinations, modifications, and environments and is capable of changes or modifications within the scope of the inventive concept as expressed herein, commensurate with the above teachings, and/or the skill or knowledge of the relevant art.

The embodiments described hereinabove are further intended to explain best modes known of practicing the invention and to enable others skilled in the art to utilize the invention in such, or other, embodiments and with the various modifications required by the particular applications or uses of the invention. Accordingly, the description is not intended to limit the invention to the form disclosed herein.

What is claimed is:

1. An order picking system for enabling a picker at a picking position to collect orders from multiple containers, the system comprising:
a container feeding mechanism configured for moving containers to and from the picking position along a feeding line in multiple container holders positioned in first and second rows at different horizontal levels with respect to ground, the container feeding mechanism is configured for simultaneously moving the container holders in the first row to the picking position in a first direction and the container holders in the second row from the picking position in a second direction opposite to the first direction, and
multiple container carriages movable along multiple parallel tracks in a direction substantially perpendicular to the feeding line so as to carry containers to and from the container feeding mechanism, each container carriage including a board for carrying one or more containers, the container carriage being configured for placing the board into first and second horizontal positions respectively corresponding to the first and second rows of the container feeding mechanism,
the container carriage being configured for placing one or more containers into a container holder in the first row when the board is in the first horizontal position, and for taking one or more containers removed from a container holder in the second row when the board is in the second horizontal position.

2. The system of claim 1, wherein the container holders in the second row are positioned at a higher horizontal level than the container holders in the first row.

3. The system of claim 2, further comprising a storage rack having multiple storage cells for storing containers in at least one row arranged at a horizontal level corresponding to the second row of the container holders.

4. The system of claim 3, wherein the container feeding mechanism is configured for moving containers from the container holders in the second row to the storage cells of the storage rack.

5. The system of claim 4, wherein the container carriages are configured for removing containers from the storage cells of the storage rack when the board is in the second position.

6. The system of claim 1, wherein the multiple container carriages deliver a sequence of containers in a predefined order to the container feeding mechanism, and include a first container carriage for delivering one or more first containers of the sequence and a second container carriage for delivering one or more second containers following the one or more first containers in the sequence.

7. The system of claim 6, further comprising a buffer area for holding the second container carriage with the one or more second containers until the first container carriage with the one or more first containers arrives.

8. The system of claim 7, wherein the container feeding mechanism is configured for simultaneously receiving the one or more first containers in a first container holder and the one or more second containers in a second container holder, where the first container holder is arranged closer to the picker than the second container holder.

9. An order picking method for enabling a picker to collect an order from multiple containers provided to the picker in a predefined sequence including one or more first containers and one or more second containers following the one or more first containers in the sequence, the method using a container feeding mechanism configured for moving containers to and from the picker along a feeding line in multiple container holders, the method comprising the steps of:
delivering containers to a buffer area using multiple container carriages movable along multiple parallel tracks substantially perpendicular to the feeding line, the multiple container carriages including a first container carriage for carrying the one or more first containers and a second container carriage for carrying the one or more second containers,
holding the second container carriage in the buffer area until the first container carriage arrives,
controlling the first container carriage for placing the one or more first containers into a first container holder of the multiple container holders,
controlling the second container carriage for placing the one or more second containers into a second container holder of the multiple container holders substantially simultaneously with placing the one or more first containers into the first container holder, and
moving the multiple container holders using the container feeding mechanism so as to place the first container holder into a picking position accessible by the picker before the second container holder is placed into the picking position.

10. The method of claim 9, wherein the predefined sequence of containers further include one or more third containers following the first and second containers, the method further comprises the steps of:
delivering one or more third containers to the buffer area using a third container carriage of the multiple container carriages,
holding the third container carriage in the buffer area until the first and second container carriages arrive,
controlling the third container carriage to place the one or more third containers into a third container holder of the multiple container holders substantially simultaneously with placing the first and second containers into the first and second container holders, and
moving the multiple container holders using the container feeding mechanism so as to place the third container holder into the picking position after the first and second container holders are placed into the picking position.

11. The method of claim 9, wherein:
the container feeding mechanism is configured for moving the multiple container holders positioned in first and second rows at different horizontal levels with respect to ground, the container holders in the first row are moved to the picking position in a first direction simultaneously with moving the container holders in the second row from the picking position in a second direction opposite to the first direction,
each container carriage includes a board for carrying one or more containers and is configured for raising the board into first and second positions respectively corresponding to the first and second rows of the container feeding mechanism, and
the container carriages are configured for placing containers into the container holders in the first row when the board is in the first horizontal position, and for taking containers removed from the container holders in the second row when the board is in the second horizontal position.

12. The method of claim 11, wherein the container holders in the second row are positioned at a higher horizontal level than the container holders in the first row.

13. The method of claim 12, further comprising the step of moving containers from the container holders in the second row to storage cells of a storage rack having multiple storage cells for storing containers in at least one row arranged at a horizontal level corresponding to the second row of the container holders.

14. The method of claim 13, further comprising the step of controlling a container carriage to remove one or more containers from the storage cell of the storage rack and place the one or more containers onto the board when the board is in the second horizontal position.
